(19) United States
(12) Patent Application Publication
(10) Pub. No.: US 2025/0284079 A1
(43) Pub. Date: Sep. 11, 2025

(54) MULTI-COUPLER ARCHITECTURES FOR OPTICAL CO-PACKAGING

(71) Applicant: Intel Corporation, Santa Clara, CA (US)

(72) Inventors: Xavier F. Brun, Chandler, AZ (US); Jonas G. Croissant, Maricopa, AZ (US)

(73) Assignee: Intel Corporation, Santa Clara, CA (US)

(21) Appl. No.: 18/597,344

(22) Filed: Mar. 6, 2024

(51) Int. Cl. G02B 6/43

(52) U.S. Cl. CPC G02B 6/43

(57) ABSTRACT

An apparatus comprising a coupler comprising a first interface to attach to a first photonic integrated circuit; a second interface to attach to a second photonic integrated circuit; and a waveguide to couple an optical channel of the first photonic integrated circuit to an optical channel of the second photonic integrated circuit.

### BACKGROUND

High-speed optical interconnects are crucial to meet the continuously increasing data rate demands of modern data centers and computing systems. Computing components may be packaged with optical interfaces to enable them to communicate over high-speed optical interconnects rather than traditional electrical interconnects. An optical interface typically includes a photonic integrated circuit (PIC) to send and receive optical signals over optical channels.

### BRIEF DESCRIPTION OF THE DRAWINGS

FIG. 1 illustrates a multi-coupler connecting two photonic integrated circuit dies together, in accordance with any of the embodiments disclosed herein.

FIG. 2 illustrates a multi-coupler connected to four photonic integrated circuit dies, in accordance with any of the embodiments disclosed herein.

FIG. 3 illustrates a multi-coupler connected to six photonic integrated circuit dies, in accordance with any of the embodiments disclosed herein.

FIG. 4 illustrates a multi-coupler connected to eight photonic integrated circuit dies, in accordance with any of the embodiments disclosed herein.

FIG. 5 illustrates a multi-coupler connected to three photonic integrated circuit dies, in accordance with any of the embodiments disclosed herein.

FIG. 6 illustrates a different arrangement of a multi-coupler connected to four PIC dies, in accordance with any of the embodiments disclosed herein.

FIG. 7 illustrates a different arrangement of a multi-coupler connected to eight PIC dies, in accordance with any of the embodiments disclosed herein.

FIG. 8 illustrates another different arrangement of a multi-coupler connected to eight photonic integrated circuit dies, in accordance with any of the embodiments disclosed herein.

FIG. 9 illustrates a plurality of multi-couplers that are each connected to eight photonic integrated circuit dies, in accordance with any of the embodiments disclosed herein.

FIG. 10 illustrates a flow for connecting photonic integrated circuit dies to a multi-coupler, in accordance with any of the embodiments disclosed herein.

FIG. 11 illustrates a flow for connecting photonic integrated circuit dies to a multi-coupler, in accordance with any of the embodiments disclosed herein.

FIG. 12 illustrates a flow for connecting photonic integrated circuit dies to a multi-coupler, in accordance with any of the embodiments disclosed herein.

FIG. 13 illustrates multi-couplers connected to photonic integrated circuit die arrays, in accordance with any of the embodiments disclosed herein.

FIG. 14 illustrates a multi-coupler utilizing V-groove coupling, in accordance with any of the embodiments disclosed herein.

FIG. 15 illustrates a multi-coupler utilizing V-groove coupling and kinematic features, in accordance with any of the embodiments disclosed herein.

FIG. 16 illustrates a multi-coupler utilizing V-groove-less kinematic coupling, in accordance with any of the embodiments disclosed herein.

FIG. 17 illustrates a multi-coupler utilizing V-groove coupling with coupler shoulders, in accordance with any of the embodiments disclosed herein.

FIG. 18 illustrates a multi-coupler utilizing V-groove coupling and kinematic features with coupler shoulders, in accordance with any of the embodiments disclosed herein.

FIG. 19 illustrates a hybrid multi-coupler, in accordance with any of the embodiments disclosed herein.

FIG. 20 illustrates a multi-coupler utilizing fiber coupling, in accordance with any of the embodiments disclosed herein.

FIG. 21 illustrates a multi-coupler utilizing photonic bumps, in accordance with any of the embodiments disclosed herein.

FIG. 22 illustrates a package with a multi-coupler embedded in a package substrate, in accordance with any of the embodiments disclosed herein.

FIG. 23 illustrates a package with a multi-coupler above a package substrate, in accordance with any of the embodiments disclosed herein.

FIG. 24 provides a schematic illustration of a cross-sectional view of an example integrated circuit device, in accordance with any of the embodiments disclosed herein.

FIG. 25 is a top view of a wafer and dies that may be included in a microelectronic assembly, in accordance with any of the embodiments disclosed herein.

FIG. 26 is a cross-sectional side view of an integrated circuit device that may be included in a microelectronic assembly, in accordance with any of the embodiments disclosed herein.

FIG. 27 is a cross-sectional side view of an integrated circuit device assembly that may include a microelectronic assembly, in accordance with any of the embodiments disclosed herein.

FIG. 28 is a block diagram of an example electrical device that may include a microelectronic assembly, in accordance with any of the embodiments disclosed herein.

### DETAILED DESCRIPTION

High-speed optical interconnects are crucial to meet the continuously increasing data rate demands of modern data centers and computing systems. For example, computing components (e.g., processors, accelerators, field programmable gate arrays (FPGAs), switches, memory/storage, other application specific integrated circuit (ASIC) nodes) may be packaged with optical interfaces to enable them to communicate over high-speed optical interconnects rather than traditional electrical interconnects. An optical interface typically uses a photonic integrated circuit (PIC) to send and receive optical signals over optical channels.

The packaging of multiple PICs and systems is typically done via butterfly systems with multiple distinct couplers or fiber arrays. For example, multiple optical couplers or multiple fiber arrays may attach to two or more PICs, however such methods may be time-consuming and/or relatively costly.

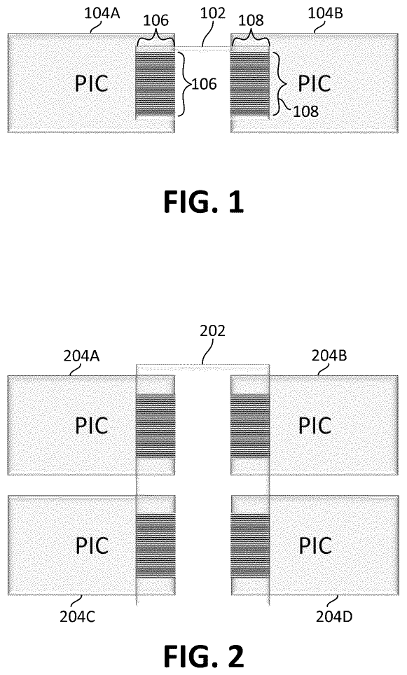

FIG. 1 illustrates a multi-coupler 102 connecting two PICs 104A and 104B together, in accordance with any of the embodiments disclosed herein. In various embodiments of the present disclosure, a single optical coupler connects multiple PIC dies together, thus enabling advanced optical co-packaging for two or more PICs or systems leveraging multifunctional couplers. Embodiments are directed to various multi-coupler architectures and assembly techniques.

One or more embodiments described herein may provide one or more technical advantages, such as reduced cost packaging and/or higher yield due to simpler assembly and/or better alignment, direct data transfer between PICs via a single optical coupler (e.g., resulting in better signaling performance), and/or improved optical co-packaging flexibility.

A PIC (e.g., 104A, 104B), sometimes referred to as an integrated optical circuit, is an integrated circuit device that incorporates photonic components to create a functional circuit. For example, a PIC may be capable of detecting, generating, transporting, and/or processing light. Unlike electronic integrated circuits (EICs) that rely on electrons, PICs may utilize particles of light called photons. A PIC may enable the manipulation of information signals carried by optical wavelengths, typically within the visible spectrum or near infrared range.

A PIC may be used to send and/or receive optical signals via optical channels (e.g., a medium through which optical signals are transmitted). In various embodiments, a PIC may send and/or receive optical signals on behalf of another component (e.g., of the same package), such as a processing unit (e.g., an XPU as described below), network interface controller (NIC), storage, memory, I/O device, or other integrated circuit.

A PIC may include components and circuitry for sending and receiving optical signals, such as one or more electromagnetic radiation sources (e.g., laser diodes (LD)/modulators (LD-MOD), oscillators, light emitting diodes (LEDs), etc.), e.g., for transmitting optical signals; photodiodes (PD), e.g., for receiving optical signals; other optical elements (e.g., polarizers, phase shifters, filters, multiplexers, attenuators, waveguides, optical couplers, collimation/refocusing lenses, reflection mirrors, or amplifiers); active elements (e.g., transistors); or passive elements (e.g., resistors, capacitors, or inductors), or other suitable components. In various embodiments, the components of the PIC may be fabricated using any suitable methods, such as semiconductor photolithographic and deposition methods.

A waveguide, whether present in a PIC or in another location referenced herein (e.g., in a multi-coupler (e.g., 102), may guide optical signals. A waveguide may also perform any of coupling, switching, splitting, multiplexing, or demultiplexing optical signals. In some instances, a waveguide may include any component configured to feed, or launch, an electromagnetic signal into a medium of propagation such as an optical fiber.

A waveguide may be formed in any suitable manner, such as by lithography or laser scribing. In some embodiments, a technique known as direct laser writing (DLW) may be used to generate waveguides with three dimensional (3D) structures (e.g., within a glass substrate). In some embodiments, the waveguides in a PIC are aligned along an optical axis of the PIC.

A PIC may be controlled by an associated EIC which may be electrically coupled to the PIC. For example, a PIC may be electrically coupled to a surface of an EIC via conductive contacts (e.g., bumps/micro-bumps) of the PIC. In various embodiments, the PIC may be on one die while the EIC is on a separate die, or a PIC may be integrated with an EIC on the same die.

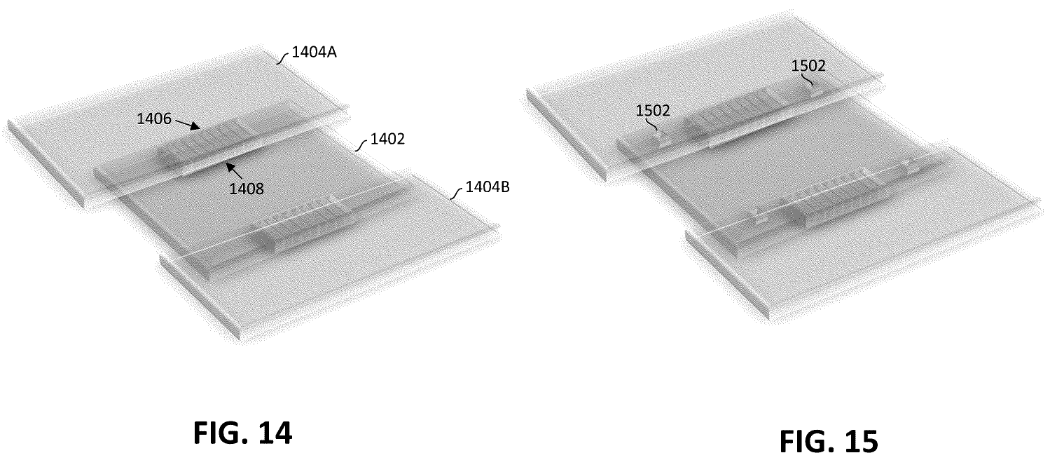

A PIC may also include an interface (e.g., 106 or 108) for coupling to a corresponding interface of the multi-coupler 102. The interfaces may comprise any suitable structures for coupling optical channels of the PIC to optical channels of the multi-coupler 102. In some embodiments, the interfaces of the optical multi-coupler and the PICs may include complementary mating and alignment features (e.g., mating protrusions and receptacles, pins and pin holes, grooves, etc.) to ensure mating with the requisite degree of alignment to cause waveguides in a PIC to be precisely aligned with waveguides in the optical multi-coupler. For example, when the optical multi-coupler is attached to a PIC, the respective mating and alignment features engage, which causes the waveguides in the optical multi-coupler to precisely align with the waveguides in the PIC. In various embodiments, edge coupling, grating couplers, interfaces with or without V-grooves, or/and kinematic features may all be incorporated to couple PIC interfaces to multi-coupler interfaces. FIGS. 14-21 illustrate example interfaces for PICs and multi-couplers and such interfaces will be explained in more detail in connection with these FIGS.

In some embodiments, a PIC may include bump fields for electrical connections to other dies (e.g., an EIC or a bridge die such as an embedded multi-die interconnect bridge (EMIB)) or to a package. In some embodiments, the bump fields may be on a side of the die (e.g., a top side) that is opposite to a side of the die (e.g., a bottom side) at which the interface 106 is located.

An optical multi-coupler 102, which may also be referred to as an optical interposer, is used to optically couple, or route optical signals (e.g., light) between multiple PICs 104. The optical multi-coupler 102 may comprise a first interface to optically couple to the interface 106 of the first PIC 104A and a second interface to optically couple to the interface 108 of the second PIC 104B. An interface of the multi-coupler may be designed to mate with a corresponding interface of a PIC (e.g., on a surface of the PIC).

The multi-coupler may include a plurality of waveguides between its first interface and second interface, to couple optical channels of the first PIC to optical channels of the second PIC. The waveguides may route optical signals between the respective interfaces. The optical multi-coupler 102 may optionally include various other optical and/or electrical routing features, such as through-glass vias, reflection mirrors, and so forth.

In various embodiments, the waveguides may each extend in a straight line from a first interface of the multi-coupler 102 to the second interface of the multi-coupler. In other embodiments, the waveguides may take other suitable paths (e.g., mirrors may be used for one or more bends in the path of a waveguide).

In some embodiments, the interfaces of the multi-coupler 102 may be symmetrical (e.g., have the same physical structure, couple to the same number of optical channels of a PIC, etc.). In other embodiments, the interfaces of the multi-coupler 102 may be asymmetrical.

The multi-coupler may comprise (e.g., predominantly comprise) glass or other material with a suitable refractive index (e.g., a polymer-based material, a semiconductor material, a crystalline material, etc.). In some embodiments, the features (e.g., interfaces, mating/alignment features, waveguides) of the multi-coupler may be patterned in the material (e.g., glass) of the multi-coupler (e.g., using laser etching techniques). For example, waveguides may be written in the multi-coupler from one interface to another interface in order to couple optical channels of multiple PICs together through the multi-coupler.

Additional multi-coupler architectures are now explained. Any of these architectures may include any one or more of the characteristics of the components of FIG. 1 or of the other architectures described herein.

FIG. 2 illustrates a multi-coupler 202 connected to four PICs 204, in accordance with any of the embodiments disclosed herein. In this embodiment, the multi-coupler 202 includes four interfaces that each optically couple to an interface of a respective PIC 204.

Various embodiments contemplate any suitable connectivity through the multi-coupler 202 between optical channels of the PICs. For example, in one embodiment, the multi-coupler 202 may include waveguides that extend from its interface to PIC 204A to its interface to PIC 204B (to couple optical channels of PIC 204A to optical channels of PIC 204B) as well as waveguides that extend from its interface to PIC 204C to its interface with PIC 204D (to couple optical channels of PIC 204C to optical channels of PIC 204D). As another example, optical channels of one PIC may be coupled by the multi-coupler 202 to optical channels of multiple PICs 204. For example, a first optical channel of PIC 204A may be coupled to an optical channel of PIC 204B, a second optical channel of PIC 204A may be coupled to an optical channel of PIC 204C, and a third optical channel may be coupled to an optical channel of PIC 204D. Thus, optical channels that are coupled to a first interface of the multi-coupler may be coupled to optical channels of one or more of the other interfaces of the multi-coupler.

In various embodiments, the interfaces may respectively couple to the same number of optical channels of each PIC 204 or may couple to differing number of channels. Thus, PICS coupled to the same multi-coupler do not need to have the same form factor and/or number of channels.

As just one example, a first interface of the multi-coupler 202 could connect to 16 optical channels of PIC 204A, while a second interface of the multi-coupler 202 could connect to 8 optical channels of PIC 204B and 8 optical channels of PIC 204C. In this example, a multi-coupler could connect 8 optical channels of PIC 204A to 8 optical channels of PIC 204B and a separate 8 optical channels of PIC 204A to 8 optical channels of PIC 204C.

Various embodiments may thus provide flexible coupling between a plurality of PICS in a system. In some embodiments, such flexibility may be provided by utilizing reflection mirrors, features, such as through-glass vias, or other features to change light paths within the waveguides of the multi-coupler.

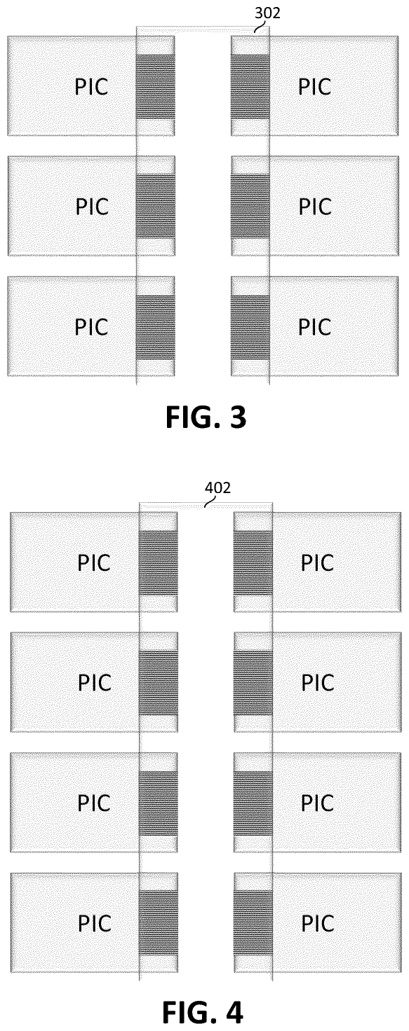

FIG. 3 illustrates a multi-coupler 302 connected to six PIC dies, in accordance with any of the embodiments disclosed herein. FIG. 4 illustrates a multi-coupler 402 connected to eight PIC dies, in accordance with any of the embodiments disclosed herein. In each of these embodiments, the multi-couplers include respective interfaces to couple to each PIC. In these embodiments, the multi-couplers are symmetrical in that the same number of PICs are coupled to either side of the multi-coupler, but other embodiments may have different numbers of PICS coupled to any suitable sides of a multi-coupler.

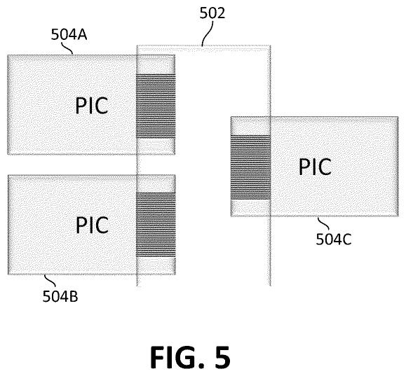

FIG. 5 illustrates a multi-coupler 502 connected to three PIC dies 504, in accordance with any of the embodiments disclosed herein. In this embodiment, two PICs 504A and 504B are coupled to two interfaces on one side of the multi-coupler 502 and one PIC 504C is coupled to an opposing side of the multi-coupler 502, though other embodiments contemplate other suitable geometric arrangements.

As described in connection with FIG. 2, the individual optical channels of the PICS may be coupled together through the multi-coupler 502 in any suitable manner. In one example, various optical channels of PIC 504A may be coupled to PIC 504B while other channels of PIC 504A may be coupled to PIC 504C. As another example, all optical channels of the interface of PIC 504A may be coupled to channels of the interface of PIC 504C, while all optical channels of the interface of PIC 504B may be coupled to different channels of the interface of PIC 504C (thus PIC 504A and PIC 504B may include fewer optical channels than PIC 504C). Other suitable coupling arrangements are contemplated herein.

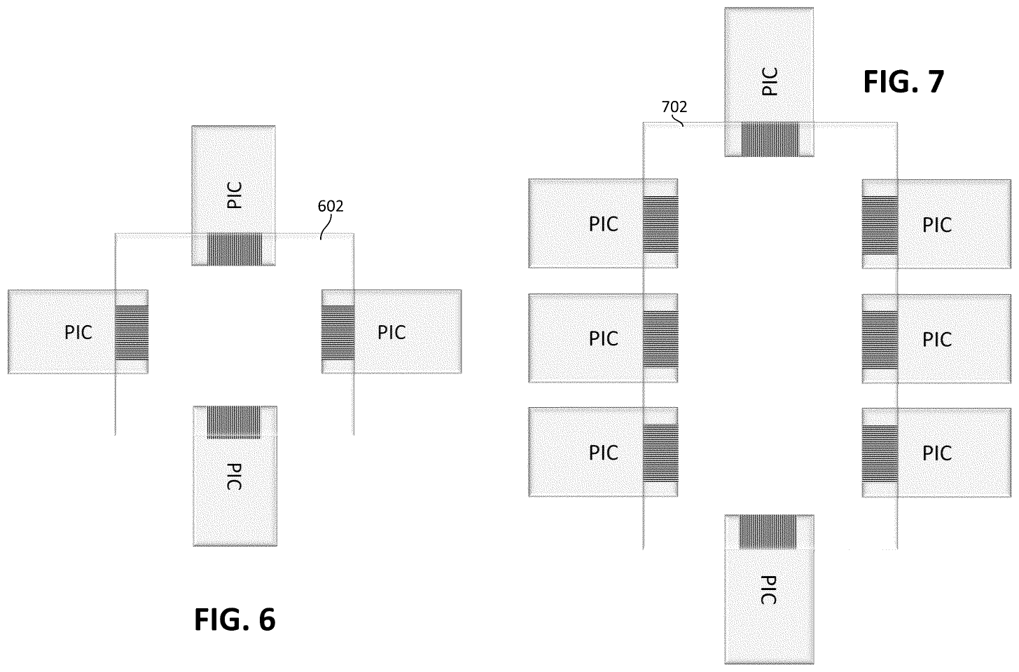

FIG. 6 illustrates a different arrangement of a multi-coupler 602 connected to four PIC dies, in accordance with any of the embodiments disclosed herein. In this arrangement, the multi-coupler 602 has one interface on each of its four outer sides to couple to respective PICs.

FIG. 7 illustrates a different arrangement of a multi-coupler 702 connected to eight PIC dies, in accordance with any of the embodiments disclosed herein. In this arrangement, the multi-coupler 702 has three interfaces on each of two of its outer sides and one interface on each of the other two outer sides to couple to respective PICs.

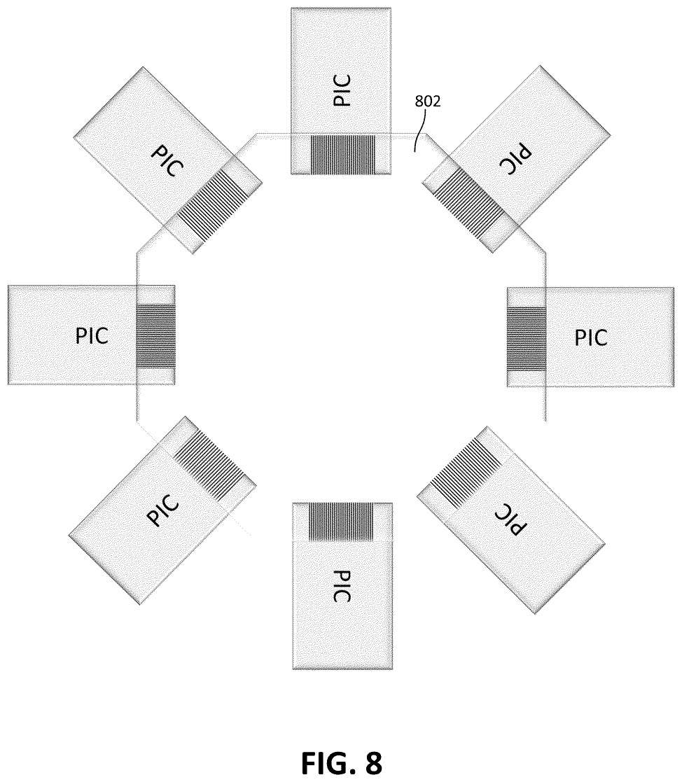

FIG. 8 illustrates a different arrangement of a multi-coupler 802 connected to eight PIC dies, in accordance with any of the embodiments disclosed herein. In the previous examples, the multi-couplers are rectilinear, but in general, a multi-coupler may have any suitable shape. In the example of FIG. 8, the multi-coupler 802 has an octagonal shape and has one interface to couple to a respective PIC at each outer side.

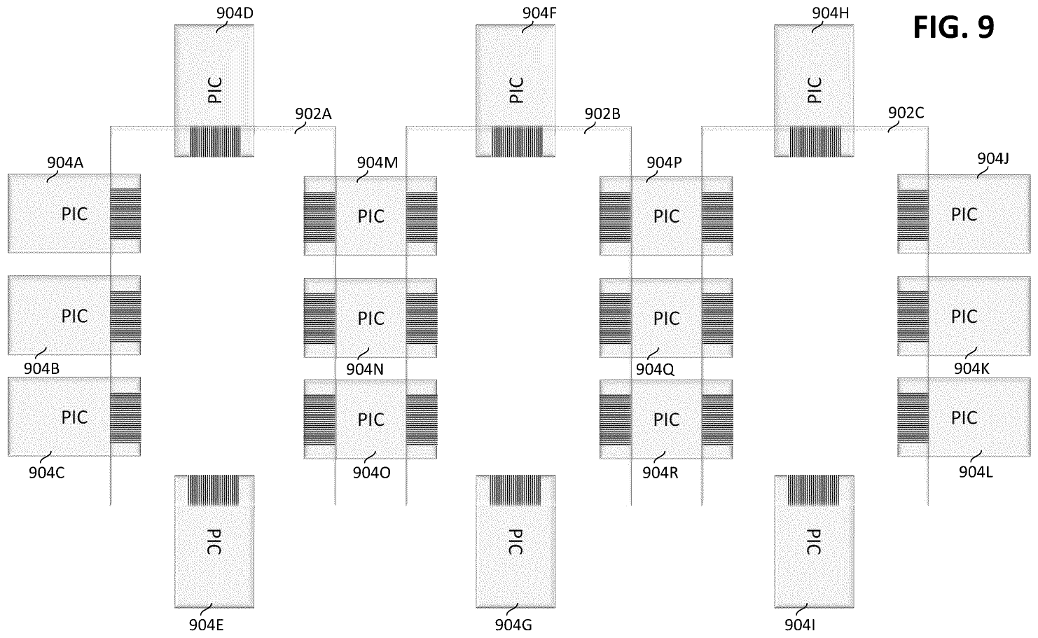

FIG. 9 illustrates a plurality of multi-couplers 902 that are each connected to eight PIC dies 904, in accordance with any of the embodiments disclosed herein. In this embodiment, some of the PICs (e.g., 904A-L) include one interface to couple to an interface of one multi-coupler, while other PICs (e.g., 904M-R) include two interfaces (on opposing outer sides) to couple to two different multi-couplers 902.

Again, in various embodiments, the optical channels of the PICs may be optically coupled together in any suitable manner. For example, a multi-coupler 902 may couple any of the optical channels of a particular PIC coupled to the multi-coupler 902 to any of the optical channels of another PIC coupled to the multi-coupler 902. In this embodiment, a PIC that is coupled to two of the multi-couplers may have optical channels of any of the PICs coupled to either of those two multi-couplers.

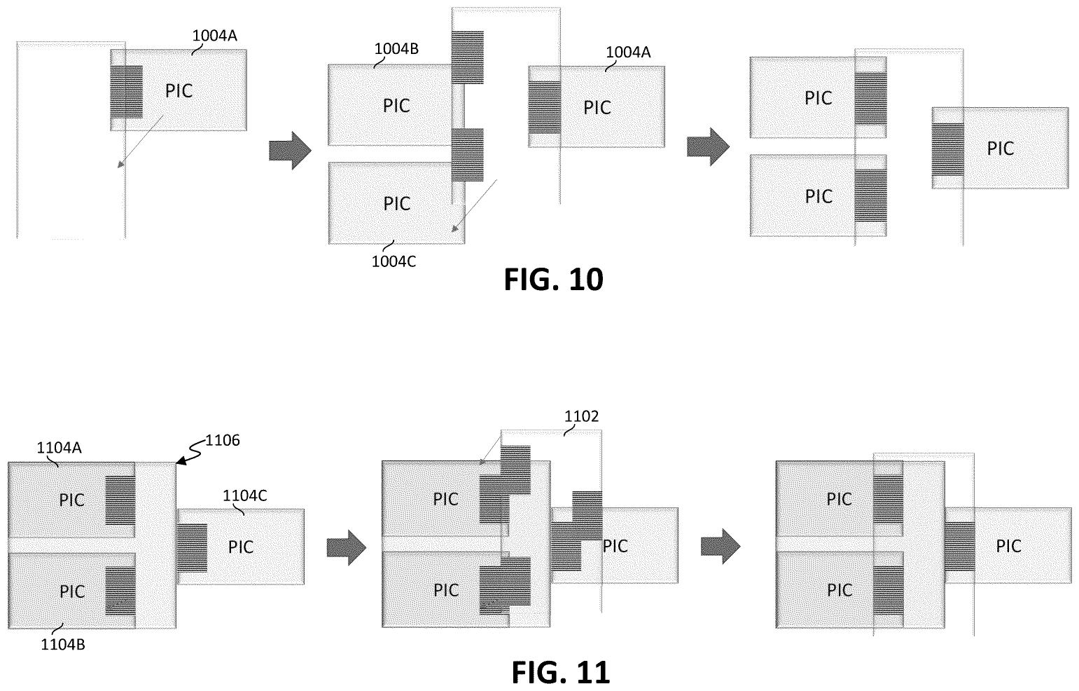

FIG. 10 illustrates a flow for connecting PIC dies 1004 to a multi-coupler 1002, in accordance with any of the embodiments disclosed herein. In a first phase, a single PIC 1004A is attached to the multi-coupler 1002. In some embodiments, the PIC 1004A may be lowered onto the multi-coupler 1002 during attachment. In a second phase, the PIC multi-coupler 1002 and the attached PIC 1004A are lowered onto the other two PICs 1004B and 1004C and then attached in a third phase.

Although in this second phase the multi-coupler is attached to two PICs (1004B and 1004C) at the same time, in other embodiments, the multi-coupler may be attached to the PICs one at a time.

In various embodiments, attachment of a PIC to a multi-coupler may include mating an interface of a PIC with a corresponding interface of the multi-coupler. In some embodiments, attachment may also include applying an adhesive (e.g., an index-matching epoxy (IME)) at or proximate to the interfaces.

FIG. 11 illustrates a flow for connecting PIC dies 1104 to a multi-coupler 1102, in accordance with any of the embodiments disclosed herein. In this instance, the multi-coupler 1102 is attached to all of the PICs 1104 at the same time.

In the first phase of the flow, a group of PICs 1104 may be singulated together (e.g., such that they are one structure 1106) from the same wafer. For example, a single structure 1106 may include multiple PICs coupled together structurally (e.g., but not electrically or optically coupled together prior to attachment to a multi-coupler). For example, the area in between the PICs that holds the PICs together after the singulation may be a wafer substrate material, such as silicon and/or other reticle materials.

In the second phase the multi-coupler 1102 may be positioned over the structure 1106. In the third phase, the multi-coupler 1102 is attached to all of the PICs 1104 simultaneously.

Such embodiments may result in improved alignment (consequently resulting in improved yield) between the PICs and the multi-coupler as this flow is less susceptible to mispositioning of the individual PICs prior to attachment to the multi-coupler.

In other embodiments, the PICs 1104 may be discrete PICs (e.g., that have been individually singulated). All of the discrete PICs 1104 may be positioned appropriately and then the multi-coupler may be lowered onto all of the PICs during the attachment.

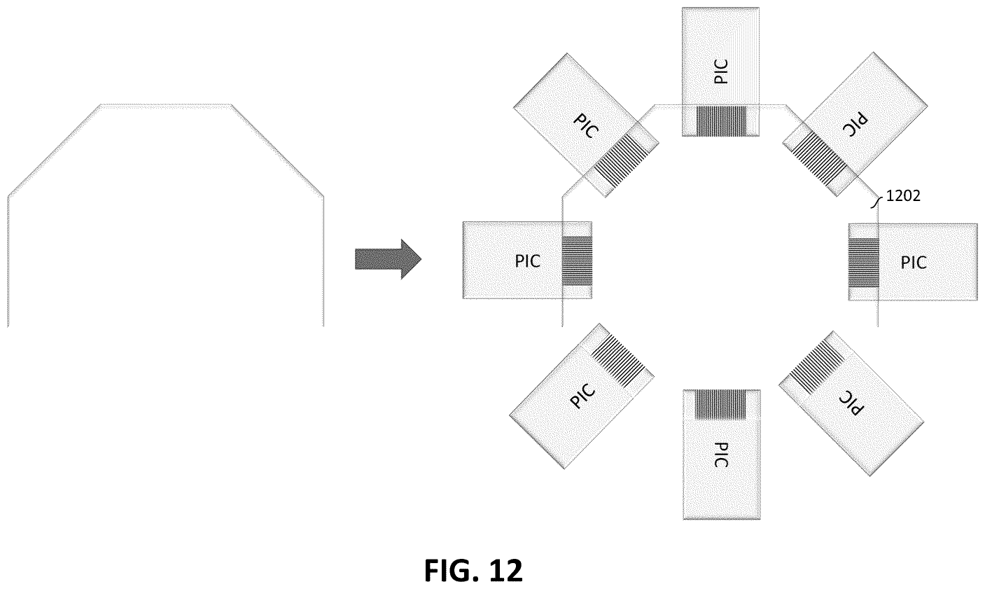

FIG. 12 illustrates a flow for connecting PIC dies to a multi-coupler 1202, in accordance with any of the embodiments disclosed herein. In the first phase, a multi-coupler 1202 is positioned and in a second phase the PICs are attached sequentially to the multi-coupler 1202.

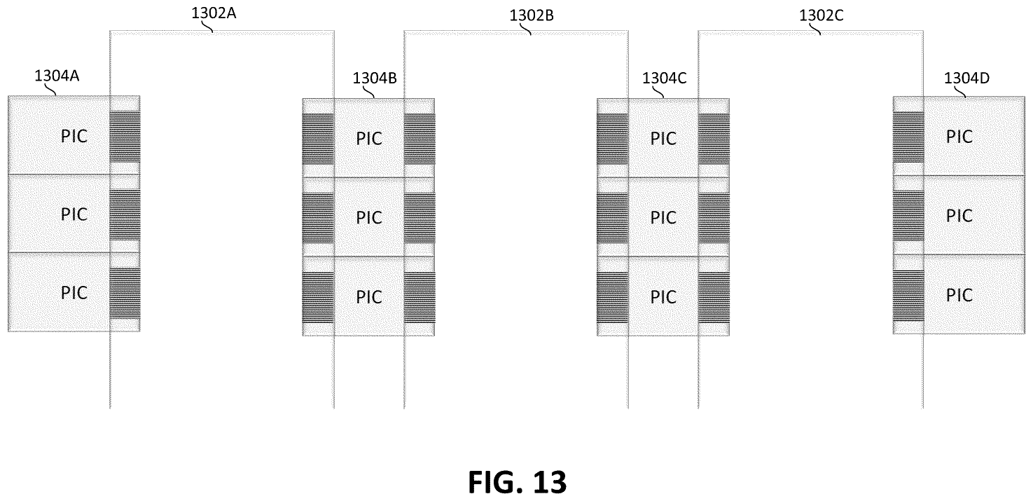

FIG. 13 illustrates multi-couplers 1302 connected to PIC die arrays 1304, in accordance with any of the embodiments disclosed herein. This embodiment is similar to the embodiment of FIG. 9, but in this instance, the PICs that are coupled to the multi-couplers 1302 are arranged in die arrays 1304 each including three adjacent PICs that are singulated together. In other embodiments, any number (e.g., two, four, etc.) of PICs may be included in an array that is then coupled to a multi-coupler. Use of such arrays may facilitate improved alignment between the PICs of the array and the multi-coupler. For example, such embodiments may prevent or reduce V-groove to multi-coupler inverted V-groove passive alignment issues (since all V-grooves from two or more PICs in an array are parallel from wafer-level manufacturing fabrication).

FIG. 14 illustrates a multi-coupler 1402 utilizing V-groove coupling, in accordance with any of the embodiments disclosed herein. In this embodiment, both interfaces of the multi-coupler 1402 utilize V-groove coupling to attach to the respective interfaces of the PICS 1404A and B.

A PIC 1404A may include an interface 1406 with waveguides and alignment grooves (e.g., V-grooves) on a surface (e.g., a top or bottom surface) of a die, wherein the interface 1406 is designed to mate with alignment ridges (with embedded waveguides) on the interface 1408 of the multi-coupler. When the alignment ridges of the multi-coupler mate with the alignment grooves of the PIC, the waveguides in the multi-coupler align with the waveguides of the PIC. In other embodiments, the interface of the PIC may include alignment ridges and the interface of the multi-coupler may include alignment grooves. In various designs, the PIC and the multi-coupler may have grooves and ridges with similar dimensions—e.g., where the grooves on the PIC are only slightly larger than the ridges on the multi-coupler—to enable the ridges to slide within the grooves for passive alignment.

FIG. 15 illustrates a multi-coupler utilizing V-groove coupling and kinematic features 1502, in accordance with any of the embodiments disclosed herein. The embodiment of FIG. 15 is similar to the embodiment of FIG. 14 with the addition of the kinematic features 1502 to the interfaces.

Kinematic features may be any suitable geometric features that facilitate proper passive alignment (e.g., by anchoring the PIC to the multi-coupler). For example, the kinematic features may be recesses and protrusions on the respective interfaces. In one example, an interface of a PIC may include one or more shallow recesses on its surface (e.g., holes in the shape of a square, circle, triangle, hexagon, etc.), while the corresponding interface of the multi-coupler may have a corresponding protrusion on its surface (e.g., square, circular, triangular, hexagonal pegs) that are designed to mate with the recesses on the interface of the PIC. In other embodiments, the interface of the PIC may include the protrusions and the interface of the multi-coupler may include the recesses. As another example, a kinematic feature may be a pyramid or a hemisphere that mates with a corresponding shape on a corresponding interface.

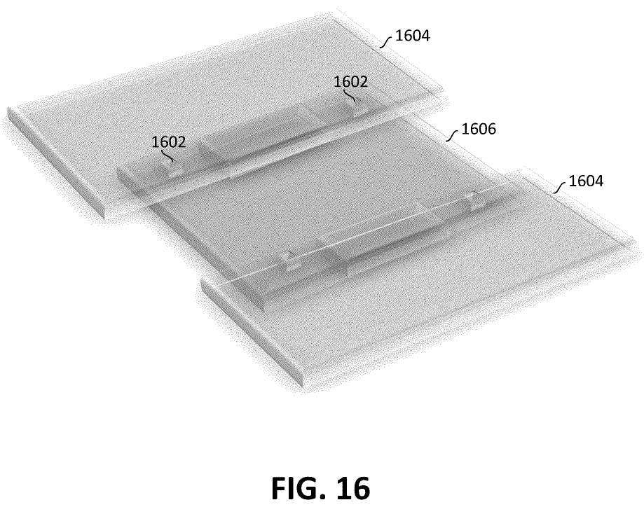

FIG. 16 illustrates a multi-coupler utilizing V-groove-less kinematic coupling, in accordance with any of the embodiments disclosed herein. In this embodiment, the kinematic features 1602 provides passive alignment between the PICs 1604 and the multi-coupler 1606. In this embodiment, one of the interfaces may include a recess into which a protrusion (e.g., with embedded waveguides) of the corresponding interface is inserted.

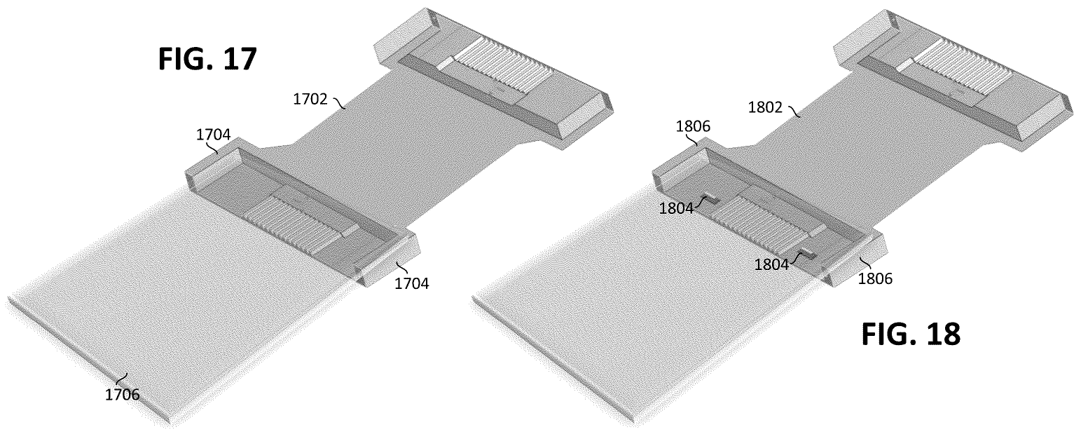

FIG. 17 illustrates a multi-coupler 1702 utilizing V-groove coupling with coupler shoulders 1704, in accordance with any of the embodiments disclosed herein. The coupler shoulders of the multi-coupler may wrap around the corners of the PIC 1706. The coupler shoulders may provide mechanical support and may facilitate alignment. In some embodiments, the coupler shoulders may be used to snap the multi-coupler into place.

Although the embodiment depicted shows the coupler shoulders wrapping around the corners and contacting the sides of the PIC, in other embodiments, the shoulders may be smaller and only extend from the multi-coupler interface area out to the corners (or proximate the corners) and not wrap around to the sides of the PIC.

FIG. 18 illustrates a multi-coupler 1802 utilizing V-groove coupling and kinematic features 1804 with coupler shoulders 1806, in accordance with any of the embodiments disclosed herein. In this embodiment, the kinematic features are essentially a set of smaller individual V-grooves that extend in a direction that is orthogonal to the other V-grooves (at which the respective waveguides are located) and may restrict movement in a different direction than the direction of movement that is restricted by the other V-grooves.

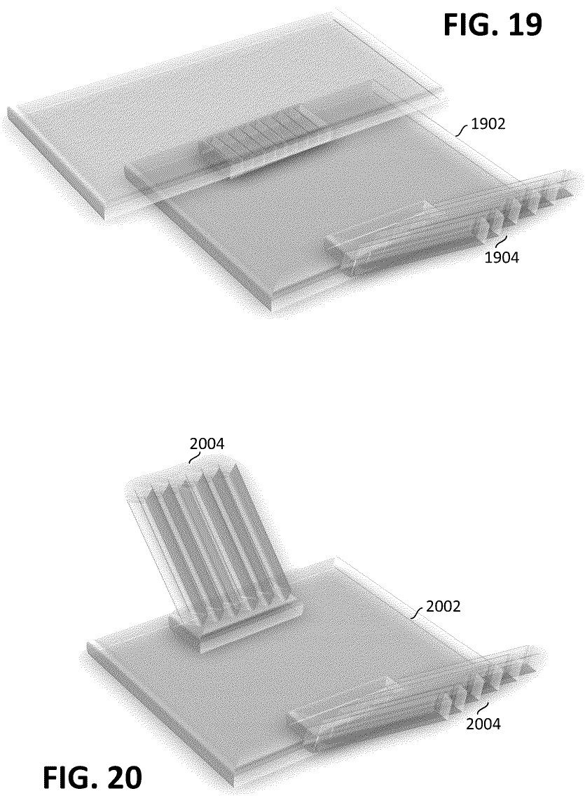

FIG. 19 illustrates a hybrid multi-coupler 1902, in accordance with any of the embodiments disclosed herein. In this embodiment, one interface of the multi-coupler may utilize V-groove coupling while another interface includes an array of fibers 1904. The array of fibers may be optically coupled to any suitable component (e.g., a PIC, a processor, a network interface controller (NIC), a storage, a memory, an I/O device, another integrated circuit, an optical connector, etc.), such as another computing component that is included in the same package or an external device or system.

In various embodiments, the fibers 1904 may attach directly to the multi-coupler or through a socket. Mechanical and optical index-matching epoxy (with respect to the material of the multi-coupler) may be used to attach the fibers 1904 to the multi-coupler.

FIG. 20 illustrates a multi-coupler 2002 utilizing fiber coupling, in accordance with any of the embodiments disclosed herein. In this embodiment, both interfaces of the multi-coupler include arrays of fibers 2004.

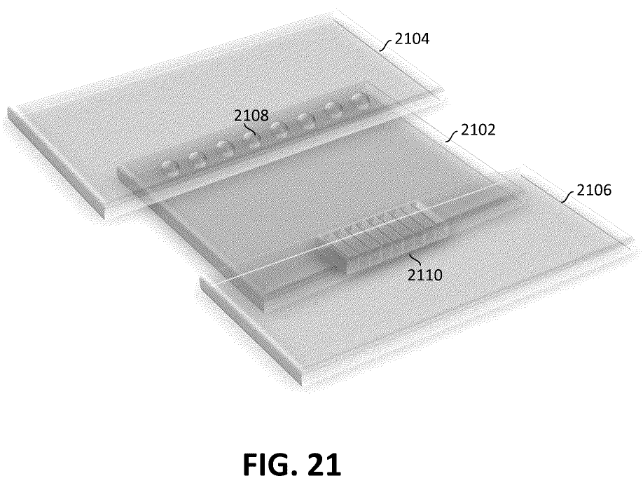

FIG. 21 illustrates a multi-coupler 2102 utilizing photonic bumps 2108, in accordance with any of the embodiments disclosed herein. In this embodiment, a first interface of the multi-coupler mates with an interface of a PIC 2104 through photonic bumps, while a second interface of the multi-coupler utilizes V-grooves 2110 to mate with an interface of PIC 2106. In various embodiments, a photonic bump may comprise a wideband deflector and a lens mirror providing beam expansion. A waveguide on the PIC may run up to the photonic bump, which then provides wideband surface coupling (e.g., as opposed to side coupling) to the multi-coupler. In some embodiments, the photonic bumps may be positioned adjacent to a grating coupler of the PIC.

As illustrated by some of the embodiments herein, a multi-coupler may include interfaces of different types or all interfaces of a multi-coupler may be of the same type. For example, all interfaces of a multi-coupler may utilize V-grooves. As another example, a first interface of a multi-coupler may utilize V-grooves, a second interface of a multi-coupler may utilize kinematic features and/or coupler shoulders, a third interface of a multi-coupler may utilize photonic bumps, and so on. Any suitable permutations of types of interfaces may be included on a multi-coupler.

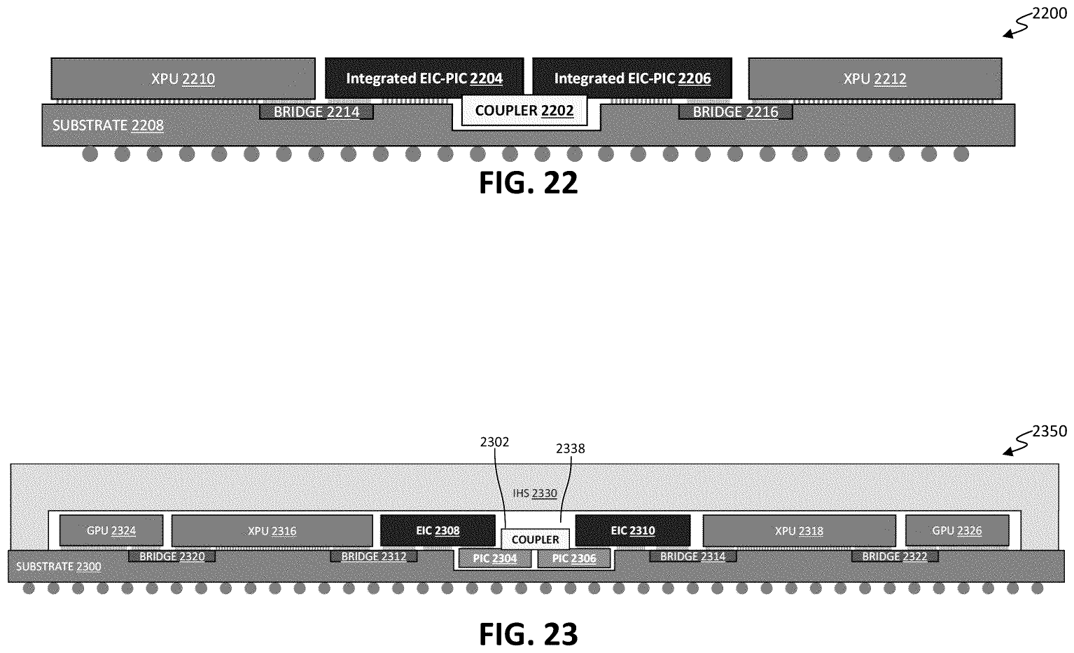

FIG. 22 illustrates a package 2200 with a multi-coupler 2202 embedded in a package substrate 2208, in accordance with any of the embodiments disclosed herein. In various embodiments, the multi-coupler 2202 may be free standing on the package substrate 2208, on a pedestal (e.g., a relief pad), or on a dielectric material over the package substrate 2208. In some embodiments, the package substrate 2208 may be a glass substrate or an organic substrate (e.g., made of organic compounds or materials).

In the depicted embodiment, the multi-coupler 2202 optically couples a first die 2204 that includes an integrated EIC and PIC to a second die 2206 that includes another integrated EIC and PIC. These dies may in turn be coupled to respective XPUs 2210 and 2212 via bridges (e.g., EMIBs) 2214 and 2216.

An EIC may comprise an integrated circuit configured to electrically integrate with a PIC to provide functionality of an optoelectronic assembly. An EIC may provide various functions such as one or more of driving, processing, or cleaning signals from and to the PIC or providing power at the desired voltage to the PIC. An EIC may be used to control a corresponding PIC (e.g., one integrated on the same die as the EIC as illustrated or one on a different die coupled to the EIC die) and may include components such as transistors, voltage converters, drivers, transimpedance amplifiers (TIA), carrier phase recovery (CPR) circuits, clock/data recovery (CDR) circuits, serializers/deserializers, equalizers, samplers, and so forth. The EICs may be electrically coupled to the package substrate via conductive contacts (e.g., bumps/micro-bumps), and further electrically coupled to an XPU (e.g., 2210 or 2212) via the bridges (e.g., 2214, 2216) embedded in the substrate 2208.

In various embodiments, the PICs and the EICs may be fabricated using panel level or wafer level semiconductor processing techniques and a multi-coupler may be fabricated by patterning various features (e.g., waveguides, interfaces, mating/alignment features) in a glass substrate (e.g., using laser-based machining/etching techniques).

An XPU (e.g., 2210, 2212) is attached to the top surface of the package substrate via conductive contacts (e.g., bumps/micro-bumps) and to a bridge (e.g., 2214, 2216) embedded in the substrate 2208 (e.g., an embedded multi-die interconnect bridge (EMIB)). In this manner, an XPU can use an EIC to communicate via a respective PIC to another XPU.

An XPU may include any type or combination of integrated circuitry that uses a PIC for optical communication. For example, an XPU may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

In some embodiments, the package 2200 may be part of an electronic device or system, such as a mobile device, a wearable device, a computer, a server, a video playback device, a video game console, a display device, a camera, or an appliance. For example, the package 2200 and various other electronic components may be electrically coupled to a circuit board within the electronic device.

It should be appreciated that package 2200 is merely presented as an example. In other embodiments, certain components may be omitted, added, rearranged, modified, or combined. For example, embodiments may include any number, combination, or arrangement of PICs and EICs (e.g., for higher bandwidth and/or redundancy), multi-couplers, bridges, XPUs or other computing components, substrates, surface cavities in the substrate, conductive contacts, conductive traces, vias, integrated circuit packages, and so forth.

FIG. 23 illustrates a package 2350 with a multi-coupler 2302 above a package substrate 2300, in accordance with any of the embodiments disclosed herein. In this embodiments PICs 2304 and 2306 are placed in a cavity in the substrate 2300.

In various embodiments, the multi-coupler 2302 may be free standing on the package substrate 2300, on a pedestal (e.g., a relief pad), or on a dielectric material over the package substrate 2300. In this embodiment, the multi-coupler 2302 is attached to the top sides of the PICs 2304, 2306.

The PICs are attached to respective EICs 2308, 2310. The EICs are attached to the top surface of the package substrate 2300 and to respective bridges 2312, 2314. Bridges are in turn coupled to XPUs 2316, 2318. The XPUs are coupled through other bridges 2320 and 2322 to graphics processing units (GPUs) 2324 and 2326.

A thermal insulating material 2338 may be placed between the various dies on the package and an integrated heat spreader 2330.

Although package architectures have been shown above in which two PICs are optically coupled using a multi-couplers, other contemplated package architectures may include multi-couplers coupled to any suitable number of PICs.

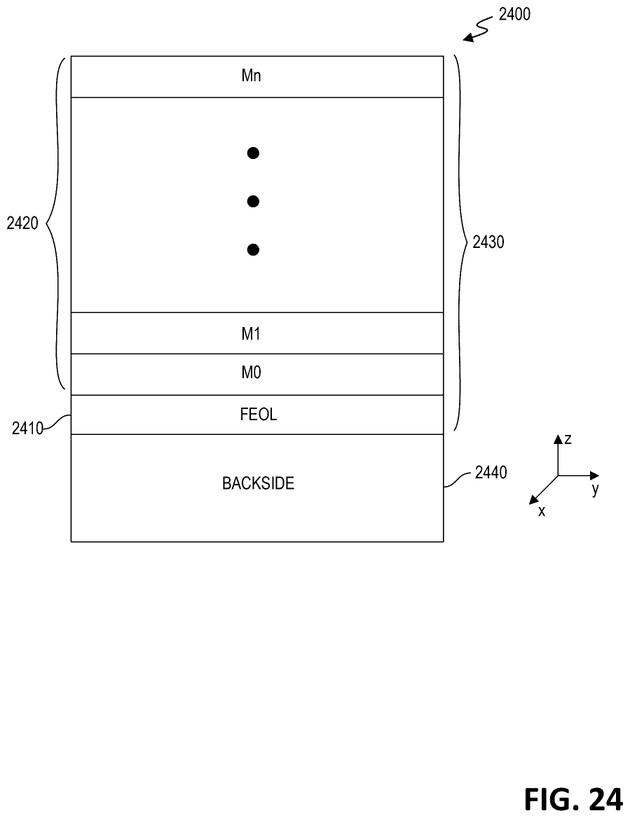

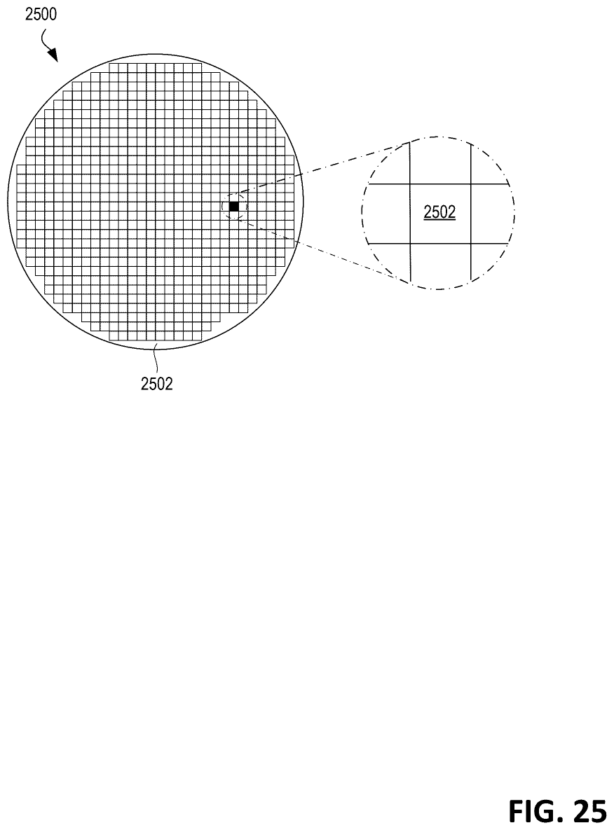

FIG. 24 provides a schematic illustration of a cross-sectional view of an example integrated circuit device (e.g., a die) 2400. The IC device 2400 may include transistors as well as other circuit elements (e.g., resistors, diodes, capacitors, inductors, etc.).

As shown in FIG. 24, the IC device 2400 may include a front side 2430 comprising a front-end-of-line (FEOL) 2410 that includes various logic layers, circuits, and devices to drive and control a logic IC. These circuits and devices may be configured for any number of functions, such as logic or compute transistors, input/output (I/O) transistors, access or switching transistors, and/or radio frequency (RF) transistors, to name a few examples. According to some embodiments, in addition to these devices and circuits, FEOL 2410 may include, for example, one or more other layers or structures associated with the semiconductor devices and circuits. For example, the FEOL can also include a substrate and one or more dielectric layers that surround active and/or conductive portions of the devices and circuits. The FEOL may also include one or more conductive contacts that provide electrical contact to transistor elements such as gate structures, drain regions, or source regions. The FEOL may also include local interconnect (e.g., vias or lines) that connect contacts to interconnect features within a back-end-of-line (BEOL) 2420.

The front side 2430 of the IC device 2400 also includes a BEOL 2420 including various metal interconnect layers (e.g., metal 0 through metal n, where n is any suitable integer). Various metal layers of the BEOL 2420 may be used to interconnect the various inputs and outputs of the FEOL 2410.

Generally speaking, each of the metal layers of the BEOL 2420, e.g., each of the layers M0-Mn shown in FIG. 24, may include a via portion and a trench/interconnect portion. Typically, the trench portion of a metal layer is above the via portion, but, in other embodiments, a trench portion may be provided below a via portion of any given metal layer of the BEOL 2420. The trench portion of a metal layer may be configured for transferring signals and power along metal lines (also sometimes referred to as “trenches”) extending in the x-y plane (e.g., in the x or y directions), while the via portion of a metal layer may be configured for transferring signals and power through metal vias extending in the z-direction, e.g., to any of the adjacent metal layers above or below. Accordingly, vias connect metal structures (e.g., metal lines or vias) from one metal layer to metal structures of an adjacent metal layer. While referred to as “metal” layers, various layers of the BEOL 2420, e.g., layers M0-Mn shown in FIG. 24, may include certain patterns of conductive metals, e.g., copper (Cu) or aluminum (Al), or metal alloys, or more generally, patterns of an electrically conductive material (e.g., including carbon based materials), formed in an insulating medium such as an interlayer dielectric (ILD). The insulating medium may include any suitable ILD materials such as silicon oxide, silicon nitride, aluminum oxide, and/or silicon oxynitride. In various embodiments, any one or more of these layers may additionally include active devices (e.g., transistors, diodes) and/or passive devices (e.g., capacitors, resistors, inductors).

The IC device 2400 may also include a backside 2440. For example, the backside 2440 may formed on the opposite side of a wafer from the front side 2430. In various embodiments, the backside 2440 may include any suitable elements to assist operation of the IC device 2400. For example, the backside 2440 may include various metal layers to deliver power to logic of the FEOL 2410.

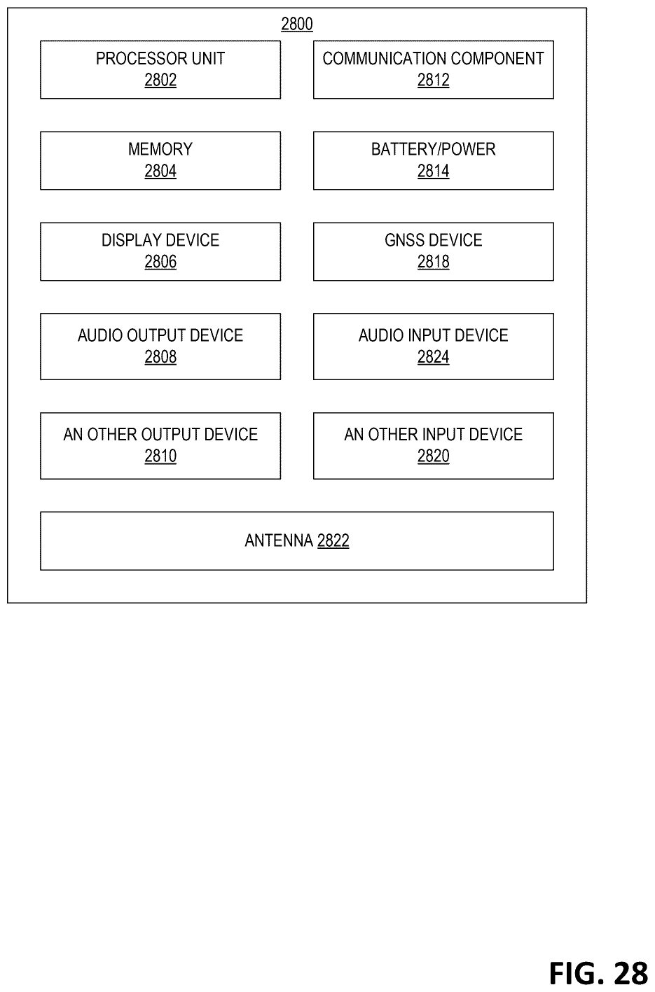

FIG. 25 is a top view of a wafer 2500 and dies 2502, wherein individual dies may include PICs, EICs, XPUs, and/or other components as disclosed herein. The wafer 2500 may be composed of semiconductor material and may include one or more dies 2502 having integrated circuit structures formed on a surface of the wafer 2500. The individual dies 2502 may be a repeating unit of an integrated circuit product that includes any suitable integrated circuit. After the fabrication of the semiconductor product is complete, the wafer 2500 may undergo a singulation process in which the dies 2502 are separated from one another to provide discrete “chips” of the integrated circuit product. The die 2502 may include one or more transistors, supporting circuitry to route electrical signals to the transistors, passive components (e.g., signal traces, resistors, capacitors, or inductors), and/or any other integrated circuit components. In some embodiments, the wafer 2500 or the die 2502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 2502. For example, a memory array formed by multiple memory devices may be formed on a same die 2502 as a processor unit (e.g., the processor unit 2802 of FIG. 28) or other logic that is configured to store information in the memory devices or execute instructions stored in the memory array. In some embodiments, various ones of the microelectronic assemblies disclosed herein may be manufactured using a die-to-wafer assembly technique in which some dies are attached to a wafer 2500 that include other dies, and the wafer 2500 is subsequently singulated.

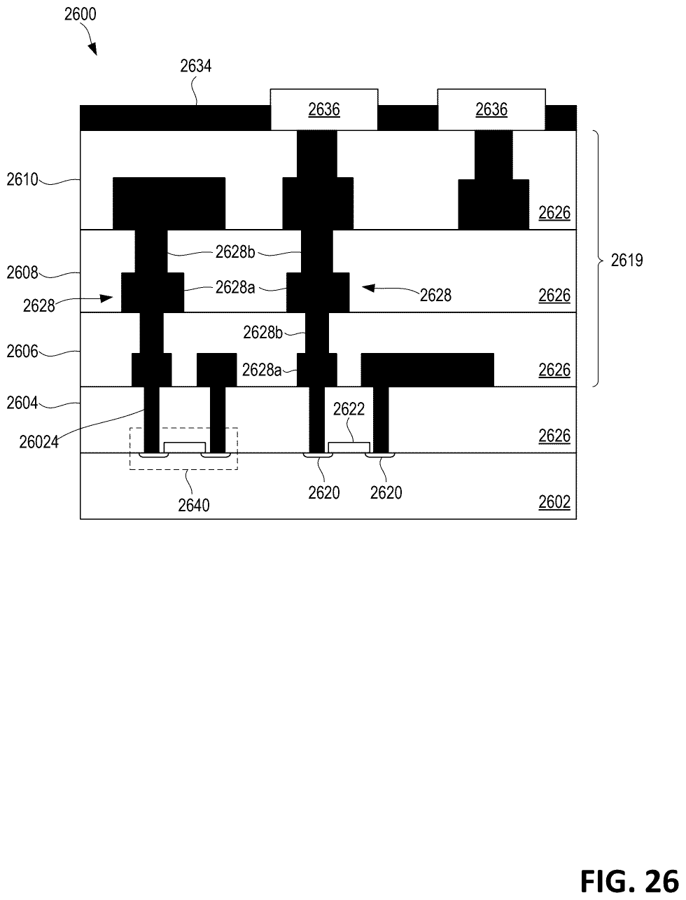

FIG. 26 is a cross-sectional side view of an integrated circuit device 2600 that may include PICs, EICs, XPUs, and/or other components as disclosed herein. as disclosed herein. One or more of the integrated circuit devices 2600 may be included in one or more dies 2502 (FIG. 25). The integrated circuit device 2600 may be formed on a die substrate 2602 (e.g., the wafer 2500 of FIG. 25) and may be included in a die (e.g., the die 2502 of FIG. 25). The die substrate 2602 may be a semiconductor substrate composed of semiconductor material systems including, for example, n-type or p-type materials systems (or a combination of both). The die substrate 2602 may include, for example, a crystalline substrate formed using a bulk silicon or a silicon-on-insulator (SOI) substructure. In some embodiments, the die substrate 2602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 2602. Although a few examples of materials from which the die substrate 2602 may be formed are described here, any material that may serve as a foundation for an integrated circuit device 2600 may be used. The die substrate 2602 may be part of a singulated die (e.g., the dies 2502 of FIG. 25) or a wafer (e.g., the wafer 2500 of FIG. 25).

The integrated circuit device 2600 may include one or more device layers 2604 disposed on the die substrate 2602. The device layer 2604 may include features of one or more transistors 2640 (e.g., metal oxide semiconductor field-effect transistors (MOSFETs)) formed on the die substrate 2602. The transistors 2640 may include, for example, one or more source and/or drain (S/D) regions 2620, a gate 2622 to control current flow between the S/D regions 2620, and one or more S/D contacts 2624 to route electrical signals to/from the S/D regions 2620. The transistors 2640 may include additional features not depicted for the sake of clarity, such as device isolation regions, gate contacts, and the like. The transistors 2640 are not limited to the type and configuration depicted in FIG. 26 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

A transistor 2640 may include a gate 2622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 2640 is to be a p-type metal oxide semiconductor (PMOS) or an n-type metal oxide semiconductor (NMOS) transistor. In some implementations, the gate electrode may consist of or comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 2640 along the source-channel-drain direction, the gate electrode may consist of or comprise a U-shaped structure that includes a bottom portion substantially parallel to the surface of the die substrate 2602 and two sidewall portions that are substantially perpendicular to the top surface of the die substrate 2602. In other embodiments, at least one of the metal layers that form the gate electrode may simply be a planar layer that is substantially parallel to the top surface of the die substrate 2602 and does not include sidewall portions substantially perpendicular to the top surface of the die substrate 2602. In other embodiments, the gate electrode may consist of or comprise a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 2620 may be formed within the die substrate 2602 adjacent to the gate 2622 of individual transistors 2640. The S/D regions 2620 may be formed using an implantation/diffusion process or an etching/deposition process, for example. In the former process, dopants such as boron, aluminum, antimony, phosphorous, or arsenic may be ion-implanted into the die substrate 2602 to form the S/D regions 2620. An annealing process that activates the dopants and causes them to diffuse farther into the die substrate 2602 may follow the ion-implantation process. In the latter process, the die substrate 2602 may first be etched to form recesses at the locations of the S/D regions 2620. An epitaxial deposition process may then be carried out to fill the recesses with material that is used to fabricate the S/D regions 2620. In some implementations, the S/D regions 2620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 2620 may be formed using one or more alternate semiconductor materials such as germanium or a group III-V material or alloy. In further embodiments, one or more layers of metal and/or metal alloys may be used to form the S/D regions 2620.

Electrical signals, such as power and/or input/output (I/O) signals, may be routed to and/or from the devices (e.g., transistors 2640) of the device layer 2604 through one or more interconnect layers disposed on the device layer 2604 (illustrated in FIG. 26 as interconnect layers 2606-2610). For example, electrically conductive features of the device layer 2604 (e.g., the gate 2622 and the S/D contacts 2624) may be electrically coupled with the interconnect structures 2628 of the interconnect layers 2606-2610. The one or more interconnect layers 2606-2610 may form a metallization stack (also referred to as an “ILD stack”) 2619 of the integrated circuit device 2600.

The interconnect structures 2628 (e.g., lines) may be arranged within the interconnect layers 2606-2610 to route electrical signals according to a wide variety of designs; in particular, the arrangement is not limited to the particular configuration of interconnect structures 2628 depicted in FIG. 26. Although a particular number of interconnect layers 2606-2610 is depicted in FIG. 26, embodiments of the present disclosure include integrated circuit devices having more or fewer interconnect layers than depicted.

In some embodiments, the interconnect structures 2628 may include lines 2628a and/or vias 2628b filled with an electrically conductive material such as a metal. The lines 2628a may be arranged to route electrical signals in a direction of a plane that is substantially parallel with a surface of the die substrate 2602 upon which the device layer 2604 is formed. For example, the lines 2628a may route electrical signals in a direction in and out of the page and/or in a direction across the page. The vias 2628b may be arranged to route electrical signals in a direction of a plane that is substantially perpendicular to the surface of the die substrate 2602 upon which the device layer 2604 is formed. In some embodiments, the vias 2628b may electrically couple lines 2628a of different interconnect layers 2606-2610 together.

The interconnect layers 2606-2610 may include a dielectric material 2626 disposed between the interconnect structures 2628, as shown in FIG. 26. In some embodiments, dielectric material 2626 disposed between the interconnect structures 2628 in different ones of the interconnect layers 2606-2610 may have different compositions; in other embodiments, the composition of the dielectric material 2626 between different interconnect layers 2606-2610 may be the same. The device layer 2604 may include a dielectric material 2626 disposed between the transistors 2640 and a bottom layer of the metallization stack as well. The dielectric material 2626 included in the device layer 2604 may have a different composition than the dielectric material 2626 included in the interconnect layers 2606-2610; in other embodiments, the composition of the dielectric material 2626 in the device layer 2604 may be the same as a dielectric material 2626 included in any one of the interconnect layers 2606-2610.

A first interconnect layer 2606 (referred to as Metal 1 or “M1”) may be formed directly on the device layer 2604. In some embodiments, the first interconnect layer 2606 may include lines 2628a and/or vias 2628b, as shown. The lines 2628a of the first interconnect layer 2606 may be coupled with contacts (e.g., the S/D contacts 2624) of the device layer 2604. The vias 2628b of the first interconnect layer 2606 may be coupled with the lines 2628a of a second interconnect layer 2608.

The second interconnect layer 2608 (referred to as Metal 2 or “M2”) may be formed directly on the first interconnect layer 2606. In some embodiments, the second interconnect layer 2608 may include via 2628b to couple the lines 2628 of the second interconnect layer 2608 with the lines 2628a of a third interconnect layer 2610. Although the lines 2628a and the vias 2628b are structurally delineated with a line within individual interconnect layers for the sake of clarity, the lines 2628a and the vias 2628b may be structurally and/or materially contiguous (e.g., simultaneously filled during a dual-damascene process) in some embodiments.

The third interconnect layer 2610 (referred to as Metal 3 or “M3”) (and additional interconnect layers, as desired) may be formed in succession on the second interconnect layer 2608 according to similar techniques and configurations described in connection with the second interconnect layer 2608 or the first interconnect layer 2606. In some embodiments, the interconnect layers that are “higher up” in the metallization stack 2619 in the integrated circuit device 2600 (i.e., farther away from the device layer 2604) may be thicker that the interconnect layers that are lower in the metallization stack 2619, with lines 2628a and vias 2628b in the higher interconnect layers being thicker than those in the lower interconnect layers.

The integrated circuit device 2600 may include a solder resist material 2634 (e.g., polyimide or similar material) and one or more conductive contacts 2636 formed on the interconnect layers 2606-2610. In FIG. 26, the conductive contacts 2636 are illustrated as taking the form of bond pads. The conductive contacts 2636 may be electrically coupled with the interconnect structures 2628 and configured to route the electrical signals of the transistor(s) 2640 to external devices. For example, solder bonds may be formed on the one or more conductive contacts 2636 to mechanically and/or electrically couple an integrated circuit die including the integrated circuit device 2600 with another component (e.g., a printed circuit board). The integrated circuit device 2600 may include additional or alternate structures to route the electrical signals from the interconnect layers 2606-2610; for example, the conductive contacts 2636 may include other analogous features (e.g., posts) that route the electrical signals to external components.

In some embodiments in which the integrated circuit device 2600 is a double-sided die, the integrated circuit device 2600 may include another metallization stack (not shown) on the opposite side of the device layer(s) 2604. This metallization stack may include multiple interconnect layers as discussed above with reference to the interconnect layers 2606-2610, to provide conductive pathways (e.g., including conductive lines and vias) between the device layer(s) 2604 and additional conductive contacts (not shown) on the opposite side of the integrated circuit device 2600 from the conductive contacts 2636.

In other embodiments in which the integrated circuit device 2600 is a double-sided die, the integrated circuit device 2600 may include one or more through silicon vias (TSVs) through the die substrate 2602; these TSVs may make contact with the device layer(s) 2604, and may provide conductive pathways between the device layer(s) 2604 and additional conductive contacts (not shown) on the opposite side of the integrated circuit device 2600 from the conductive contacts 2636. In some embodiments, TSVs extending through the substrate can be used for routing power and ground signals from conductive contacts on the opposite side of the integrated circuit device 2600 from the conductive contacts 2636 to the transistors 2640 and any other components integrated into the integrated circuit device (e.g., die) 2600, and the metallization stack 2619 can be used to route I/O signals from the conductive contacts 2636 to transistors 2640 and any other components integrated into the integrated circuit device (e.g., die) 2600.

Multiple integrated circuit devices 2600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

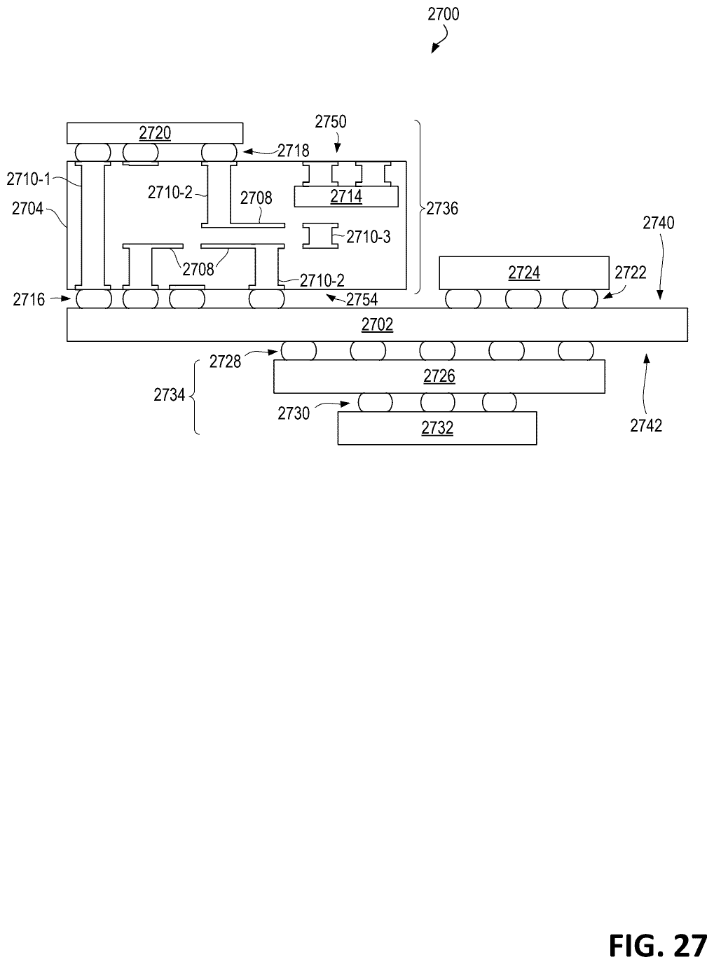

FIG. 27 is a cross-sectional side view of an integrated circuit device assembly 2700 that may include multi-couplers, PICs, EICs, XPUs, and/or other components as disclosed herein. In some embodiments, the integrated circuit device assembly 2700 may be a microelectronic assembly. The integrated circuit device assembly 2700 includes a number of components disposed on a circuit board 2702 (which may be a motherboard, system board, mainboard, etc.). The integrated circuit device assembly 2700 includes components disposed on a first face 2740 of the circuit board 2702 and an opposing second face 2742 of the circuit board 2702; generally, components may be disposed on one or both faces 2740 and 2742.

In some embodiments, the circuit board 2702 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 2702. In other embodiments, the circuit board 2702 may be a non-PCB substrate. The integrated circuit device assembly 2700 illustrated in FIG. 27 includes a package-on-interposer structure 2736 coupled to the first face 2740 of the circuit board 2702 by coupling components 2716. The coupling components 2716 may electrically and mechanically couple the package-on-interposer structure 2736 to the circuit board 2702, and may include solder balls (as shown in FIG. 27), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 2736 may include an integrated circuit component 2720 coupled to an interposer 2704 by coupling components 2718. The coupling components 2718 may take any suitable form for the application, such as the forms discussed above with reference to the coupling components 2716. Although a single integrated circuit component 2720 is shown in FIG. 27, multiple integrated circuit components may be coupled to the interposer 2704; indeed, additional interposers may be coupled to the interposer 2704. The interposer 2704 may provide an intervening substrate used to bridge the circuit board 2702 and the integrated circuit component 2720.

The integrated circuit component 2720 may be a packaged or unpackaged integrated circuit product that includes one or more integrated circuit dies (e.g., the die 2502 of FIG. 25, the integrated circuit device 2600 of FIG. 26) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 2720, a single monolithic integrated circuit die comprises solder bumps attached to contacts on the die. The solder bumps allow the die to be directly attached to the interposer 2704. The integrated circuit component 2720 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 2720 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 2720 comprises multiple integrated circuit dies, the dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 2720 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 2704 may spread connections to a wider pitch or reroute a connection to a different connection. For example, the interposer 2704 may couple the integrated circuit component 2720 to a set of ball grid array (BGA) conductive contacts of the coupling components 2716 for coupling to the circuit board 2702. In the embodiment illustrated in FIG. 27, the integrated circuit component 2720 and the circuit board 2702 are attached to opposing sides of the interposer 2704; in other embodiments, the integrated circuit component 2720 and the circuit board 2702 may be attached to a same side of the interposer 2704. In some embodiments, three or more components may be interconnected by way of the interposer 2704.

In some embodiments, the interposer 2704 may be formed as a PCB, including multiple metal layers separated from one another by layers of dielectric material and interconnected by electrically conductive vias. In some embodiments, the interposer 2704 may be formed of an epoxy resin, a fiberglass-reinforced epoxy resin, an epoxy resin with inorganic fillers, a ceramic material, or a polymer material such as polyimide. In some embodiments, the interposer 2704 may be formed of alternate rigid or flexible materials that may include the same materials described above for use in a semiconductor substrate, such as silicon, germanium, and other group III-V and group IV materials. The interposer 2704 may include metal interconnects 2708 and vias 2710, including but not limited to through hole vias 2710-1 (that extend from a first face 2750 of the interposer 2704 to a second face 2754 of the interposer 2704), blind vias 2710-2 (that extend from the first or second faces 2750 or 2754 of the interposer 2704 to an internal metal layer), and buried vias 2710-3 (that connect internal metal layers).

In some embodiments, the interposer 2704 can comprise a silicon interposer. Through silicon vias (TSV) extending through the silicon interposer can connect connections on a first face of a silicon interposer to an opposing second face of the silicon interposer. In some embodiments, an interposer 2704 comprising a silicon interposer can further comprise one or more routing layers to route connections on a first face of the interposer 2704 to an opposing second face of the interposer 2704.

The interposer 2704 may further include embedded devices 2714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 2704. The package-on-interposer structure 2736 may take the form of any of the package-on-interposer structures known in the art.

The integrated circuit device assembly 2700 may include an integrated circuit component 2724 coupled to the first face 2740 of the circuit board 2702 by coupling components 2722. The coupling components 2722 may take the form of any of the embodiments discussed above with reference to the coupling components 2716, and the integrated circuit component 2724 may take the form of any of the embodiments discussed above with reference to the integrated circuit component 2720.

The integrated circuit device assembly 2700 illustrated in FIG. 27 includes a package-on-package structure 2734 coupled to the second face 2742 of the circuit board 2702 by coupling components 2728. The package-on-package structure 2734 may include an integrated circuit component 2726 and an integrated circuit component 2732 coupled together by coupling components 2730 such that the integrated circuit component 2726 is disposed between the circuit board 2702 and the integrated circuit component 2732. The coupling components 2728 and 2730 may take the form of any of the embodiments of the coupling components 2716 discussed above, and the integrated circuit components 2726 and 2732 may take the form of any of the embodiments of the integrated circuit component 2720 discussed above. The package-on-package structure 2734 may be configured in accordance with any of the package-on-package structures known in the art.

FIG. 28 is a block diagram of an example electrical device 2800 that may include multi-couplers, PICs, EICs, XPUs, and/or other components as disclosed herein. For example, any suitable components of the electrical device 2800 may include one or more of the integrated circuit device assemblies 2700, integrated circuit components 2720, integrated circuit devices 2600, integrated circuit dies 2502, or other components disclosed herein. A number of components are illustrated in FIG. 28 as included in the electrical device 2800, but any one or more of these components may be omitted or duplicated, as suitable for the application. In some embodiments, some or all of the components included in the electrical device 2800 may be attached to one or more motherboards mainboards, or system boards. In some embodiments, one or more of these components are fabricated onto a single system-on-a-chip (SoC) die.

Additionally, in various embodiments, the electrical device 2800 may not include one or more of the components illustrated in FIG. 28, but the electrical device 2800 may include interface circuitry for coupling to the one or more components. For example, the electrical device 2800 may not include a display device 2806, but may include display device interface circuitry (e.g., a connector and driver circuitry) to which a display device 2806 may be coupled. In another set of examples, the electrical device 2800 may not include an audio input device 2824 or an audio output device 2808, but may include audio input or output device interface circuitry (e.g., connectors and supporting circuitry) to which an audio input device 2824 or audio output device 2808 may be coupled.

The electrical device 2800 may include one or more processor units 2802 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 2802 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 2800 may include a memory 2804, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 2804 may include memory that is located on the same integrated circuit die as the processor unit 2802. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 2800 can comprise one or more processor units 2802 that are heterogeneous or asymmetric to another processor unit 2802 in the electrical device 2800. There can be a variety of differences between the processing units 2802 in a system in terms of a spectrum of metrics of merit including architectural, microarchitectural, thermal, power consumption characteristics, and the like. These differences can effectively manifest themselves as asymmetry and heterogeneity among the processor units 2802 in the electrical device 2800.

In some embodiments, the electrical device 2800 may include a communication component 2812 (e.g., one or more communication components). For example, the communication component 2812 can manage wireless communications for the transfer of data to and from the electrical device 2800. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 2812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 2812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 2812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 2812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 2812 may operate in accordance with other wireless protocols in other embodiments. The electrical device 2800 may include an antenna 2822 to facilitate wireless communications and/or to receive other wireless communications (such as amplitude modulation (AM) or frequency modulation (FM) radio transmissions).

In some embodiments, the communication component 2812 may manage wired communications, such as electrical, optical, or any other suitable communication protocols (e.g., IEEE 802.3 Ethernet standards). As noted above, the communication component 2812 may include multiple communication components. For instance, a first communication component 2812 may be dedicated to shorter-range wireless communications such as Wi-Fi or Bluetooth, and a second communication component 2812 may be dedicated to longer-range wireless communications such as global positioning system (GPS), EDGE, GPRS, CDMA, WiMAX, LTE, EV-DO, or others. In some embodiments, a first communication component 2812 may be dedicated to wireless communications, and a second communication component 2812 may be dedicated to wired communications.

The electrical device 2800 may include battery/power circuitry 2814. The battery/power circuitry 2814 may include one or more energy storage devices (e.g., batteries or capacitors) and/or circuitry for coupling components of the electrical device 2800 to an energy source separate from the electrical device 2800 (e.g., AC line power).

The electrical device 2800 may include a display device 2806 (or corresponding interface circuitry, as discussed above). The display device 2806 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 2800 may include an audio output device 2808 (or corresponding interface circuitry, as discussed above). The audio output device 2808 may include any embedded or wired or wirelessly connected external device that generates an audible indicator, such speakers, headsets, or earbuds.

The electrical device 2800 may include an audio input device 2824 (or corresponding interface circuitry, as discussed above). The audio input device 2824 may include any embedded or wired or wirelessly connected device that generates a signal representative of a sound, such as microphones, microphone arrays, or digital instruments (e.g., instruments having a musical instrument digital interface (MIDI) output). The electrical device 2800 may include a Global Navigation Satellite System (GNSS) device 2818 (or corresponding interface circuitry, as discussed above), such as a Global Positioning System (GPS) device. The GNSS device 2818 may be in communication with a satellite-based system and may determine a geolocation of the electrical device 2800 based on information received from one or more GNSS satellites, as known in the art.

The electrical device 2800 may include an other output device 2810 (or corresponding interface circuitry, as discussed above). Examples of the other output device 2810 may include an audio codec, a video codec, a printer, a wired or wireless transmitter for providing information to other devices, or an additional storage device.

The electrical device 2800 may include an other input device 2820 (or corresponding interface circuitry, as discussed above). Examples of the other input device 2820 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 2800 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 2800 may be any other electronic device that processes data. In some embodiments, the electrical device 2800 may comprise multiple discrete physical components. Given the range of devices that the electrical device 2800 can be manifested as in various embodiments, in some embodiments, the electrical device 2800 can be referred to as a computing device or a computing system.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

It will also be understood that, although the terms “first,” “second,” and so forth may be used herein to describe various elements, these elements should not be limited by these terms. These terms are only used to distinguish one element from another, and are not intended to imply that the objects so described must be in a given sequence, either temporally, spatially, in ranking or in any other manner. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, the terms “comprising,” “including,” “having,” and the like, as used with respect to embodiments of the present disclosure, are synonymous.

The description may use the phrases “in an embodiment,” “according to some embodiments,” “in accordance with embodiments,” or “in embodiments,” which may each refer to one or more of the same or different embodiments.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 10⁷ Siemens per meter (S/m) at 20 degrees Celsius. Examples of such materials include Cu, Ag, Al, Au, W, Zn and Ni.

The term “signal” may refer to at least one current signal, voltage signal, magnetic signal, or data/clock signal.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices.

The description may use perspective-based descriptions such as top/bottom, in/out, over/under, and the like. Such descriptions are merely used to facilitate the discussion and are not intended to restrict the application of embodiments described herein to any particular orientation.

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer means that at least a part of the first material or layer is in direct physical contact with at least a part of that second material/layer. Similar distinctions are to be made in the context of component assemblies.

As used herein, “A is proximate to B” may mean that A is adjacent to B or A is otherwise near to B.

Unless otherwise specified in the specific context of use, the term “predominantly” means more than 50%, or more than half. For example, a composition that is predominantly a first constituent means more than half of the composition (e.g., by volume) is the first constituent (e.g., >50 at. %). The term “primarily” means the most, or greatest, part. For example, a composition that is primarily a first constituent means the composition has more of the first constituent (e.g., by volume) than any other constituent. A composition that is primarily first and second constituents means the composition has more of the first and second constituents than any other constituent. The term “substantially” means there is only incidental variation. For example, composition that is substantially a first constituent means the composition may further include <1% of any other constituent. A composition that is substantially first and second constituents means the composition may further include <1% of any constituent substituted for either the first or second constituent.

The terms “substantially,” “close,” “approximately,” “near,” and “about,” generally refer to being within +/−10% of a target value (unless specifically specified).

Unless otherwise specified in the explicit context of their use, the terms “substantially equal,” “about equal” or “approximately equal” mean that there is no more than incidental variation between two things so described. In the art, such variation is typically no more than +/−10% of a predetermined target value.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

Although the figures may illustrate embodiments where structures are substantially aligned to Cartesian axes (e.g., device structures having substantially vertical sidewalls), positive and negative (re-entrant) sloped feature sidewalls often occur in practice. For example, manufacturing non-idealities may cause one or more structural features to have sloped sidewalls. Thus, attributes illustrated are idealized merely for the sake of clearly describing salient features. It is to be understood that schematic illustrations may not reflect real-life process limitations which may cause the features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an apparatus comprising a coupler comprising a first interface to attach to a first photonic integrated circuit; a second interface to attach to a second photonic integrated circuit; and a waveguide to couple an optical channel of the first photonic integrated circuit to an optical channel of the second photonic integrated circuit.

Example 2 includes the subject matter of Example 1, and wherein the coupler further comprises a third interface to attach to a third photonic integrated circuit.

Example 3 includes the subject matter of any of Examples 1 and 2, and wherein the coupler further comprises a second waveguide to couple a second optical channel of the first photonic integrated circuit to an optical channel of the third photonic integrated circuit.

Example 4 includes the subject matter of any of Examples 1-3, and wherein the coupler further comprises a fourth interface to attach to a fourth photonic integrated circuit, wherein the coupler further comprises a second waveguide to couple an optical channel of the third photonic integrated circuit to an optical channel of the fourth photonic integrated circuit.

Example 5 includes the subject matter of any of Examples 1-4, and wherein the coupler predominantly comprises glass.

Example 6 includes the subject matter of any of Examples 1-5, and wherein the first interface and the second interface are of the same type.

Example 7 includes the subject matter of any of Examples 1-6, and wherein the first interface and the second interface are of different types.

Example 8 includes the subject matter of any of Examples 1-7, and wherein at least one of the first interface and the second interface comprises an interface to mate with a V-groove interface.

Example 9 includes the subject matter of any of Examples 1-8, and wherein the first interface comprises a kinematic feature to mate with a corresponding kinematic feature of the first photonic integrated circuit.

Example 10 includes the subject matter of any of Examples 1-9, and wherein at least one of the first interface and the second interface comprise coupler shoulders.

Example 11 includes the subject matter of any of Examples 1-10, and wherein at least one of the first interface and the second interface comprise photonic bumps.

Example 12 includes the subject matter of any of Examples 1-11, and further comprising a second coupler, wherein the second coupler includes a first interface to attach to a third photonic integrated circuit and a plurality of fibers directly attached to the second coupler, the plurality of fibers to couple the third photonic integrated circuit to an integrated circuit component.

Example 13 includes a system comprising a package substrate; and a coupler comprising a first interface coupled to a first photonic integrated circuit; a second interface coupled to a second photonic integrated circuit; and a waveguide coupling an optical channel of the first photonic integrated circuit to an optical channel of the second photonic integrated circuit.

Example 14 includes the subject matter of Example 13, and further including the first photonic integrated circuit and the second photonic integrated circuit.

Example 15 includes the subject matter of any of Examples 13 and 14, and further including a processor coupled to the package substrate and the first photonic integrated circuit.

Example 16 includes the subject matter of any of Examples 13-15, and further including a printed circuit board coupled to the package substrate.

Example 17 includes the subject matter of any of Examples 13-16, and further including a battery, display, or network interface communicatively coupled to the processor through the printed circuit board.

Example 18 includes the subject matter of any of Examples 13-17, and wherein the coupler further comprises a third interface coupled to a third photonic integrated circuit.

Example 19 includes the subject matter of any of Examples 13-18, and wherein the coupler further comprises a second waveguide to couple a second optical channel of the first photonic integrated circuit to an optical channel of the third photonic integrated circuit.

Example 20 includes the subject matter of any of Examples 13-19, and wherein the coupler further comprises a fourth interface coupled a fourth photonic integrated circuit, wherein the coupler further comprises a second waveguide to couple an optical channel of the third photonic integrated circuit to an optical channel of the fourth photonic integrated circuit.

Example 21 includes the subject matter of any of Examples 13-20, and wherein the coupler predominantly comprises glass.

Example 22 includes the subject matter of any of Examples 13-21, and wherein the first interface and the second interface are of the same type.

Example 23 includes the subject matter of any of Examples 13-22, and wherein the first interface and the second interface are of different types.

Example 24 includes the subject matter of any of Examples 13-23, and wherein at least one of the first interface and the second interface comprises an interface to mate with a V-groove interface.

Example 25 includes the subject matter of any of Examples 13-24, and wherein the first interface comprises a kinematic feature to mate with a corresponding kinematic feature of the first photonic integrated circuit.

Example 26 includes the subject matter of any of Examples 13-25, and wherein at least one of the first interface and the second interface comprise coupler shoulders.

Example 27 includes the subject matter of any of Examples 13-26, and wherein at least one of the first interface and the second interface comprise photonic bumps.

Example 28 includes the subject matter of any of Examples 13-27, and further comprising a second coupler, wherein the second coupler includes a first interface to attach to a third photonic integrated circuit and a plurality of fibers directly attached to the second coupler, the plurality of fibers to couple the third photonic integrated circuit to an integrated circuit component.

Example 29 includes a coupler comprising a first interface to couple to a first die comprising a first photonic integrated circuit; a second interface to couple to a second die comprising a second photonic integrated circuit; and a plurality of waveguides to optically couple the first photonic integrated circuit to the second photonic integrated circuit.

Example 30 includes the subject matter of Example 29, and wherein the first interface is to mate with a V-groove interface of the first die and wherein the second interface is to mate with a V-groove interface of the second die.

Example 31 includes the subject matter of any of Examples 29 and 30, and wherein the coupler has a rectilinear shape.

Example 32 includes the subject matter of any of Examples 29-31, and wherein the coupler further comprises a third interface to couple to a third die comprising a third photonic integrated circuit.

Example 33 includes the subject matter of any of Examples 29-32, and wherein the coupler further comprises a second waveguide to couple a second optical channel of the first die to an optical channel of the third die.

Example 34 includes the subject matter of any of Examples 29-33, and wherein the coupler further comprises a fourth interface to attach to a fourth die comprising a fourth photonic integrated circuit, wherein the coupler further comprises a second waveguide to couple an optical channel of the third die to an optical channel of the fourth die.

Example 35 includes the subject matter of any of Examples 29-34, and wherein the coupler predominantly comprises glass.

Example 36 includes the subject matter of any of Examples 29-35, and wherein the first interface and the second interface are of the same type.

Example 37 includes the subject matter of any of Examples 29-36, and wherein the first interface and the second interface are of different types.

Example 38 includes the subject matter of any of Examples 29-37, and wherein at least one of the first interface and the second interface comprises an interface to mate with a V-groove interface.

Example 39 includes the subject matter of any of Examples 29-38, and wherein the first interface comprises a kinematic feature to mate with a corresponding kinematic feature of the first photonic integrated circuit.

Example 40 includes the subject matter of any of Examples 29-39, and wherein at least one of the first interface and the second interface comprise coupler shoulders.

Example 41 includes the subject matter of any of Examples 29-40, and wherein at least one of the first interface and the second interface comprise photonic bumps.

Example 42 includes the subject matter of any of Examples 29-41, and further including a second coupler, wherein the second coupler includes a first interface to attach to a third photonic integrated circuit and a plurality of fibers directly attached to the second coupler, the plurality of fibers to couple the third photonic integrated circuit to an integrated circuit component.

Example 43 includes a method comprising forming a first interface on a coupler, the first interface to mate with an interface of a first photonic integrated circuit; forming a second interface on the coupler, the second interface to mate with an interface of a second photonic integrated circuit; and forming waveguides in the coupler between the first interface and the second interface.

Example 44 includes the subject matter of Example 43, and further including forming a third interface on the coupler, the third interface to mate with an interface of a third photonic integrated circuit.

Example 45 includes the subject matter of any of Examples 43 and 44, and further including forming second waveguides in the coupler between the first interface and the third interface.

Example 46 includes the subject matter of any of Examples 43-45, and further including forming a fourth interface to couple to a fourth photonic integrated circuit, and forming second waveguides between the third interface and the fourth interface.

Example 47 includes the subject matter of any of Examples 43-46, and wherein the coupler predominantly comprises glass.

Example 48 includes the subject matter of any of Examples 43-47, and wherein the first interface and the second interface are of the same type.

Example 49 includes the subject matter of any of Examples 43-48, and wherein the first interface and the second interface are of different types.

Example 50 includes the subject matter of any of Examples 43-49, and wherein at least one of the first interface and the second interface comprises an interface to mate with a V-groove interface.

Example 51 includes the subject matter of any of Examples 43-50, and wherein the first interface comprises a kinematic feature to mate with a corresponding kinematic feature of the first photonic integrated circuit.

Example 52 includes the subject matter of any of Examples 43-51, and wherein at least one of the first interface and the second interface comprise coupler shoulders.

Example 53 includes the subject matter of any of Examples 43-52, and wherein at least one of the first interface and the second interface comprise photonic bumps.

Example 54 includes the subject matter of any of Examples 43-53, and further including forming a second coupler, wherein the second coupler includes a first interface to attach to a third photonic integrated circuit and a plurality of fibers directly attached to the second coupler, the plurality of fibers to couple the third photonic integrated circuit to an integrated circuit component.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

1. An apparatus comprising:
a coupler comprising:
a first interface to attach to a first photonic integrated circuit;
a second interface to attach to a second photonic integrated circuit; and
a waveguide to couple an optical channel of the first photonic integrated circuit to an optical channel of the second photonic integrated circuit.

2. The apparatus of claim 1, wherein the coupler further comprises a third interface to attach to a third photonic integrated circuit.

3. The apparatus of claim 2, wherein the coupler further comprises a second waveguide to couple a second optical channel of the first photonic integrated circuit to an optical channel of the third photonic integrated circuit.

4. The apparatus of claim 2, wherein the coupler further comprises a fourth interface to attach to a fourth photonic integrated circuit, wherein the coupler further comprises a second waveguide to couple an optical channel of the third photonic integrated circuit to an optical channel of the fourth photonic integrated circuit.

5. The apparatus of claim 1, wherein the coupler predominantly comprises glass.

6. The apparatus of claim 1, wherein the first interface and the second interface are of the same type.

7. The apparatus of claim 1, wherein the first interface and the second interface are of different types.

8. The apparatus of claim 1, wherein at least one of the first interface and the second interface comprises an interface to mate with a V-groove interface.

9. The apparatus of claim 1, wherein the first interface comprises a kinematic feature to mate with a corresponding kinematic feature of the first photonic integrated circuit.

10. The apparatus of claim 1, wherein at least one of the first interface and the second interface comprise coupler shoulders.

11. The apparatus of claim 1, wherein at least one of the first interface and the second interface comprise photonic bumps.

12. The apparatus of claim 1, further comprising a second coupler, wherein the second coupler includes a first interface to attach to a third photonic integrated circuit and a plurality of fibers directly attached to the second coupler, the plurality of fibers to couple the third photonic integrated circuit to an integrated circuit component.

13. A system comprising:
a package substrate; and
a coupler comprising:
a first interface coupled to a first photonic integrated circuit;
a second interface coupled to a second photonic integrated circuit; and
a waveguide coupling an optical channel of the first photonic integrated circuit to an optical channel of the second photonic integrated circuit.

14. The system of claim 13, further comprising the first photonic integrated circuit and the second photonic integrated circuit.

15. The system of claim 14, further comprising a processor coupled to the package substrate and the first photonic integrated circuit.

16. The system of claim 15, further comprising a printed circuit board coupled to the package substrate.

17. The system of claim 16, further comprising a battery, display, or network interface communicatively coupled to the processor through the printed circuit board.

18. A coupler comprising:
a first interface to couple to a first die comprising a first photonic integrated circuit;
a second interface to couple to a second die comprising a second photonic integrated circuit; and
a plurality of waveguides to optically couple the first photonic integrated circuit to the second photonic integrated circuit.

19. The coupler of claim 18, wherein the first interface is to mate with a V-groove interface of the first die and wherein the second interface is to mate with a V-groove interface of the second die.

20. The coupler of claim 18, wherein the coupler has a rectilinear shape.
